(19) United States
(12) Patent Application Publication
(10) Pub. No.: US 2017/0148418 A1
(43) Pub. Date: May 25, 2017

(54) DISPLAY METHOD AND DISPLAY APPARATUS

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventor: Tian Zhang, Beijing (CN)

(21) Appl. No.: 15/112,553

(22) PCT Filed: Dec. 31, 2015
(86) PCT No.: PCT/CN2015/100136

§ 371 Date: Jul. 19, 2016

(30) Foreign Application Priority Data
Jul. 20, 2015 (CN) 201510427672.5

(51) Int. Cl. G09G 5/02

(52) U.S. Cl. CPC G09G 5/02; G09G 2300/0452; G09G 2320/0252; G09G 2330/023

(57) ABSTRACT

There are disclosed a display method and a display apparatus. The display method comprises: determining whether the images to be displayed are special images (S101); transmitting instructions corresponding to the images to be displayed when it is determined that the images to be displayed are special images (S102); receiving the instructions, generating image data of the images to be displayed according to the instructions, and transmitting the image data (S103); receiving the image data, and displaying the images to be displayed according to the image data (S104); and transmitting the image data of the images to be displayed when it is determined that the display image is not a special image (S105). The display method can further comprise classifying the images to be displayed (S100). By classifying the images to be displayed, for a special image, a mode of firstly transmitting the instructions corresponding to the images to be displayed and then generating the image data of the images to be displayed according to the instructions is adopted. Compared with the existing mode of transmitting the image data of the images to be displayed, this mode would reduce volume of transmitted data. In this way, it can not only reduce power consumption of the display apparatus, but also increase transmission efficiency, so that the frame frequency of displaying images by a display apparatus can be ensured without raising the transmission rate of a signal line, so as to avoid the problem of producing electromagnetic interference.

### TECHNICAL FIELD

The present disclosure relates to a display method and a display apparatus.

### BACKGROUND

Generally, the display apparatus comprises a processor, a driving chip and a display panel. A process of displaying images by a display apparatus generally comprises: first, a processor transmits image data of images to be displayed to a driving chip; then, the driving chip receives the image data transmitted by the processor, and transmits received image data to the display panel; finally, the display panel receives the image data transmitted by the driving chip, and displays the images to be displayed according to the received image data.

At present, with the constant development of display technique, a resolution of images displayed by the display apparatus becomes higher and higher, such that transmitted image data becomes larger and larger, thereby resulting in an increase of power consumption of the display apparatus. Furthermore, when transmission rate of a signal line for transmitting the image data is unchanged, it would also result in reduction of efficiency of transmitting the image data, such that a frame frequency of displaying images by the display apparatus reduces. In order to ensure the frame frequency of displaying images by the display apparatus, the transmission rate of the signal line for transmitting the image data can be increased. However, this would easily cause electromagnetic interference produced between the signal line and other elements. In particular, for small-size mobile display devices such as a mobile phone, a notebook computer or the like, a relatively high transmission rate of the signal line would easily produce electromagnetic interference on communication channels, so that performance of the display apparatus would be influenced.

### SUMMARY

In view of this, there are provided in embodiments of the present disclosure a display method and a display apparatus, which are used to reduce power consumption of the display apparatus, improve transmission efficiency, and avoid a problem of producing electromagnetic interference under the premise of ensuring frame frequency of displaying images by a display apparatus.

Therefore, there is provided in an embodiment of the present disclosure a display method, comprising:

determining whether images to be displayed are special images; transmitting instructions corresponding to the images to be displayed when it is determined that the images to be displayed are special images;

receiving the instructions, generating image data of the images to be displayed according to the instructions, and transmitting the image data; and

receiving the image data, and displaying the images to be displayed according to the image data.

In a possible implementation, the method provided in an embodiment of the present disclosure further comprises:

transmitting image data of the images to be displayed when it is determined that the images to be displayed is not a special image; and

receiving the image data, and displaying the images to be displayed according to the image data.

In a possible implementation, in the method provided in the embodiment of the present disclosure, the determining whether the images to be displayed are special images comprises:

determining whether the images to be displayed are special images according to gray scale values of all sub-pixels in the images to be displayed.

In a possible implementation, in the method provided in an embodiment of the present disclosure, the determining whether the images to be displayed are special images according to the gray scale values of all sub-pixels in the images to be displayed comprises:

determining whether gray scale values of sub-pixels with a same chromatic resistance color in the images to be displayed are the same; if yes, determining that the images to be displayed are special images.

In a possible implementation, in the method provided in an embodiment of the present disclosure, the determining whether the images to be displayed are special images according to the gray scale values of all sub-pixels in the images to be displayed comprises:

determining whether the gray scale values of all sub-pixels in the images to be displayed change gradually in a horizontal direction or in a vertical direction and change values are determined; if yes, determining that the images to be displayed are special images.

In the display method provided in the embodiment of the present disclosure, it further comprises classifying the images to be displayed, so determine which images to be displayed are special images.

There is further provided a display apparatus in an embodiment of the present disclosure, comprising:

a processing unit, configured to determine whether images to be displayed are special images, and transmit instructions corresponding to the images to be displayed when it is determined that the images to be displayed are special images;

a driving unit, configured to receive the instructions, generate image data of the images to be displayed according to the instructions, and transmit the image data; and

a display unit, configured to receive the image data, and display the images to be displayed according to the image data.

In a possible implementation, in the apparatus provided in the embodiment of the present disclosure, the processing unit is further configured to transmit the image data of the images to be displayed when it is determined that the images to be displayed is not a special image;

The driving unit is further configured to receive and transmit the image data.

In a possible implementation, in the apparatus provided in the embodiment of the present disclosure, the processing unit is configured to determine whether the images to be displayed are special images according to gray scale values of all sub-pixels in the images to be displayed.

In a possible implementation, in the apparatus provided in the embodiment of the present disclosure, the processing unit is configured to determine whether gray scale values of sub-pixels with a same chromatic resistance color in the images to be displayed are the same, and determine that the images to be displayed are special images when it is determined that the gray scale values of sub-pixels with a same chromatic resistance color in the images to be displayed are the same.

In a possible implementation, in the apparatus provided in the embodiment of the present disclosure, the processing unit is configured to determine whether the gray scale values of all sub-pixels in the images to be displayed change gradually in a horizontal direction or in a vertical direction and change values are determined, and determine that the images to be displayed are special images when it is determined that the gray scale values of all sub-pixels in the images to be displayed change gradually in a horizontal direction or in a vertical direction and change values are determined.

In the display apparatus provided in the embodiment of the present disclosure, it further comprises a unit configured to classify the images to be displayed, so as to determine which images to be displayed are special images.

There are provided in the embodiments of the present disclosure a display method and a display apparatus. The display method comprises: determining whether the images to be displayed are special images; transmitting instructions corresponding to the images to be displayed when it is determined that the images to be displayed are special images; receiving instructions, generating image data of the images to be displayed, and transmitting the image data; receiving the image data, and displaying the images to be displayed according to the image data. By classifying the images to be displayed, for a special image, a mode of firstly transmitting the instructions corresponding to the images to be displayed and then generating the image data of the images to be displayed according to the instructions is adopted. Compared with the existing mode of transmitting the image data of the images to be displayed, this mode would reduce volume of transmitted data. In this way, it can not only reduce power consumption of the display apparatus, but also raise transmission efficiency, so that the frame frequency of displaying images by the display apparatus can be ensured without raising the transmission rate of the signal lines, so as to avoid the problem of producing electromagnetic interference.

### BRIEF DESCRIPTION OF THE DRAWINGS

FIG. 1 is a flow chart of a display method provided in an embodiment of the present disclosure;

FIG. 2 is a schematic diagram of a display apparatus provided in an embodiment of the present disclosure.

### DETAILED DESCRIPTION

Specific implementations of a display method and a display apparatus provided in embodiments of the present disclosure will be described in detail by combining with drawings.

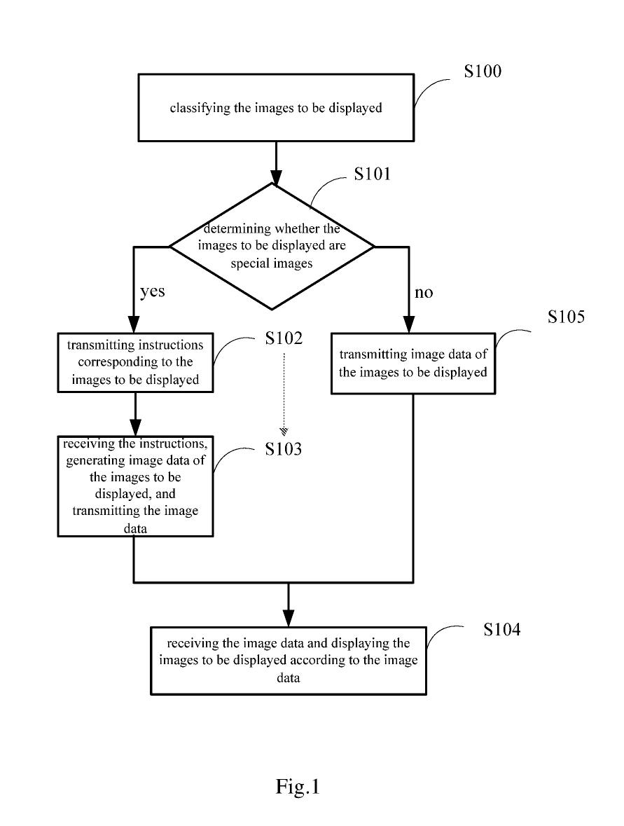

FIG. 1 shows a flow chart of a display method provided in an embodiment of the present disclosure. As shown in FIG. 1, the method comprises following operation processes:

in step S101, determining whether the images to be displayed are special images; and executing steps S102 to S104 when it is determined that the images to be displayed are special images;

in step S102, transmitting instructions corresponding to the images to be displayed;

in step S103, receiving instructions, generating image data of the images to be displayed according to the instructions, and transmitting the image data; and

in step S104, receiving the image data, and displaying the images to be displayed according to the image data.

Exemplarily, in the flow chart of the display method as shown in FIG. 1, before execution of step S101, step S100 can be further executed. In step S100, the images to be displayed are classified, to determine which images to be displayed are special images.

The display method provided in the embodiment of the present disclosure adopts, for special images, a mode of firstly transmitting the instructions corresponding to the images to be displayed and then generating the image data of the images to be displayed according to the instructions by classifying the images to be displayed. Compared with the existing mode of transmitting the image data of the images to be displayed, this mode would reduce volume of transmitted data. In this way, it can not only reduce power consumption of the display apparatus, but also increase transmission efficiency, so that frame frequency of displaying images by a display apparatus can be ensured without increasing the transmission rate of the signal line, so as to avoid the problem of producing electromagnetic interference.

It should be noted that in step S102 of the method provided in the embodiment of the present disclosure, i.e., in the step of transmitting the instructions corresponding to the images to be displayed, the instructions can reflect information of color, gray scale or the like of corresponding images to be displayed, so as to execute subsequently step S103 in the method provided in the embodiment of the present disclosure, and generate the image data of the images to be displayed according to the instructions. Herein, the data volume of the instructions corresponding to the images to be displayed is obviously smaller than data volume of the image data of the images to be displayed.

In the specific implementation, in the method provided in the embodiment of the present disclosure, when it is determined in step S101 that the images to be displayed is not a special image, as shown in FIG. 1, following processes can be further implemented:

in step S105, transmitting image data of the images to be displayed; and

in step S104, receiving the image data, and displaying the images to be displayed according to the image data.

Exemplarily, when step S101 in the method provided in the embodiment of the present disclosure is executed, i.e., when it is determined whether the images to be displayed are special images, it can be implemented by the following manner: determining whether the images to be displayed are special images according to gray scale values of all sub-pixels in the images to be displayed. It should be noted that the display apparatus for displaying the images to be displayed generally comprises a plurality of pixels arranged in matrix, each of which is composed of three or four sub-pixels with different chromatic resistance colors. For example, each pixel is composed of three sub-pixels with different chromatic resistance colors. The chromatic resistance colors corresponding to the three sub-pixels are generally red (R), green (G) and blue (B).

In the specific implementation, in the method provided in the embodiment of the present disclosure, determining whether the images to be displayed are special images according to the gray scale values of all sub-pixels in the images to be displayed can be implemented by the following manner: determining whether gray scale values of sub-pixels with the same chromatic resistance color in the images to be displayed are the same, if yes, determining that the images to be displayed are special images. For example, in the images to be displayed, the gray scale value of sub-pixels with a red (R) chromatic resistance color are 255, gray scale value of sub-pixels with a green (G) chromatic resistance color are 0, and gray scale values of sub-pixels with a blue (B) chromatic resistance color are 0, that is, the images to be displayed is R255, and the images to be displayed are special images; similarly, for example, G255 and B255 and so on are special images.

In the specific implementation, in the method provided in the embodiment of the present disclosure, determining whether the images to be displayed are special images according to the gray scale values of all sub-pixels in the images to be displayed can be further implemented by the following manner: determining whether the gray scale values of all sub-pixels in the images to be displayed change gradually in a horizontal direction or vertical direction and change values are determined; if yes, determining that the images to be displayed are special images. Images whose gray scale values of all sub-pixels change gradually in a horizontal direction or in a vertical direction and change values are determined are gradient gray-scale images. In particular, in the gradient image, the gray scale values of all sub-pixels can change gradually in a horizontal direction or in a vertical direction, and the change value can be a fixed value; or, the change value may also be a plurality of determined values, to which no further limitation is given. For example, when the gray scale values of all sub-pixels change gradually with a fixed value in a horizontal direction or in a vertical direction, the gray scale values of all sub-pixels can decrease gradually with a fixed value in a direction from left to right; or the gray scale values of all sub-pixels can increase gradually with a fixed value in a direction from left to right; or the gray scale values of all sub-pixels can decrease gradually with a fixed value in a direction from top to bottom; or the gray scale values of all sub-pixels can increase gradually with a fixed value in a direction from top to bottom; to which no limitation is made herein.

Of course, in the method provided in the embodiment of the present disclosure, it may be determined whether the images to be displayed are special images by other similar manners, to which no further limitation is given herein.

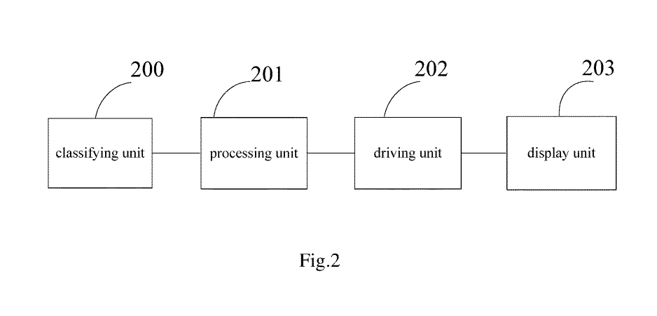

Based on the same inventive concept, there is further provided in an embodiment of the present disclosure a display apparatus. FIG. 2 shows a schematic diagram of a display apparatus provided in an embodiment of the present disclosure. As shown in FIG. 2, the display apparatus comprises: a processing unit 201, a driving unit 202 and a display unit 203.

In the display apparatus as shown in FIG. 2, the processing unit 201 can be configured to determine whether images to be displayed are special images, and transmit instructions corresponding to the images to be displayed when it is determined that the images to be displayed are special images. For example, the processing unit may be an application processor (AP) or the like.

The driving unit 202 can configured to receive instructions, generate image data of the images to be displayed according to the instructions, and transmit the image data. For example, the driving unit may be a driving chip or the like.

The display unit 203 can be configured to receive the image data, and display the images to be displayed according to the image data. For example, the display unit may be a display panel or the like.

Exemplarily, the display apparatus as shown in FIG. 2 further comprises a classifying unit 200 configured to classify the images to be displayed, so as to determine which images to be displayed are special images.

Exemplarily, in the display apparatus provided in the embodiment of the present disclosure, as shown in FIG. 2, its operating process can be described as follows: the processing unit 201 determines whether the images to be displayed are special images, and transmits instructions corresponding to the images to be displayed to the driving unit 202 when it is determined that the images to be displayed are special images; the driving unit 202 receives the instructions transmitted by the processing unit 201, generates image data of the images to be displayed according to the received instructions, and transmits generated image data to the display unit 203; and the display unit 203 receives the image data transmitted by the driving unit 202, and displays the images to be displayed according to the received image data.

It should be noted that in the apparatus provided in the embodiment of the present disclosure, as shown in FIG. 2, the instructions transmitted by the processing unit 201 can reflect information of color and gray scale of the corresponding images to be displayed, so that the driving unit 202 can generate the image data of the corresponding images to be displayed according to the instructions when receiving the instructions, wherein the data volume of the instructions corresponding to the images to be displayed is smaller than the data volume of the image data to be displayed evidently.

Alternatively, in the apparatus provided in the embodiment of the present disclosure, as shown in FIG. 2, the processing unit 201 can be further configured to transmit the image data of the images to be displayed when it is determined that the images to be displayed is not a special image; the driving unit 202 can further be used to receive and transmit the image data. In this case, the operation process of the display apparatus can be described as follows: the processing unit 201 determines whether the images to be displayed are special images, and transmits the image data of the images to be displayed to the driving unit 202 when it is determined that the images to be displayed is not a special image; the driving unit 202 receives the image data transmitted by the processing unit 201, and transmits the received image data to the display unit 203; and the display unit 203 receives the image data transmitted by the driving unit 202, and displays the images to be displayed according to the received image data.

It should be noted that the above apparatus provided in the embodiment of the present disclosure is particularly applicable to a small-size mobile display apparatus such as a mobile phone and a notebook computer or the like, because in the existing small-size mobile display apparatuses such as a mobile phone and a notebook computer or the like, a signal line (it is generally a MIPI line) between the processing unit and the driving unit is easier to produce electromagnetic interference on the communication channel in the display apparatus. The processing unit in the apparatus provided in the embodiment of the present disclosure transmits the instructions corresponding to the images to be displayed to the MIPI line when it is determined that the images to be displayed are special images, which would reduce the volume of data transmitted by the MIPI line. In this way, it can not only reduce power consumption of the display apparatus, but also raise transmission efficiency, so that the frame frequency of displaying images by the display apparatus can be ensured without raising transmission rate of the MIPI line, so as to improve the problem that the MIPI line produces electromagnetic interference on the communication channel in the display apparatus evidently.

In the specific implementation, in the apparatus provided in the embodiment of the present disclosure, as shown in FIG. 2, the processing unit 201 can be configured to determine whether the images to be displayed are special images according to gray scale values of all sub-pixels in the images to be displayed. It should be noted that the display apparatus for displaying the images to be displayed generally comprises a plurality of pixels arranged in matrix, each of which is composed of three or four sub-pixels with different chromatic resistance colors. For example, each pixel is composed of three sub-pixels with different chromatic resistance colors. The chromatic resistance colors corresponding to the three sub-pixels are generally red (R), green (G) and blue (B).

In specific implementation, in the apparatus provided in the embodiment of the present disclosure, as shown in FIG. 2, the processing unit 201 can be configured to determine whether gray scale values of sub-pixels with the same chromatic resistance color in the images to be displayed are the same, and determine that the images to be displayed are special images when it is determined that gray scale values of sub-pixels with the same chromatic resistance color in the images to be displayed are the same. For example, in the images to be displayed, gray scale values of sub-pixels with a red (R) chromatic resistance color are 255, gray scale value of sub-pixels with a green (G) chromatic resistance color are 0, and gray scale values of sub-pixels with a blue (B) chromatic resistance color are 0, that is, the images to be displayed is R255, and the images to be displayed are special images; similarly, for example, G255 and B255 and so on are special images.

In the specific implementation, in the apparatus provided in the embodiment of the present disclosure, as shown in FIG. 2, the processing unit 201 can be configured to determine whether gray scale values of all sub-pixels in the images to be displayed change gradually in a horizontal direction or vertical direction and change values are determined, and determine that the images to be displayed are special images when it is determined that gray scale values of all sub-pixels in the images to be displayed change gradually in a horizontal direction or vertical direction and change values are determined. Images whose gray scale values of all sub-pixels change gradually in a horizontal direction or in a vertical direction and change values are determined are gradient gray-scale images. In particular, in the gradient images, the gray scale values of all sub-pixels can change gradually in a horizontal direction or in a vertical direction, and the change value can be a fixed value; or, the change value may also be a plurality of determined values, to which no further limitation is given. For example, when the gray scale values of all sub-pixels change gradually with a fixed value in a horizontal direction or in a vertical direction, the gray scale values of all sub-pixels can decrease gradually with a fixed value in a direction from left to right; or the gray scale values of all sub-pixels can increase gradually with a fixed value in a direction from left to right; or the gray scale values of all sub-pixels can decrease gradually with a fixed value in a direction from top to bottom; or the gray scale values of all sub-pixels can increase gradually with a fixed value in a direction from top to bottom; to which no limitation is given herein.

Of course, in the apparatus provided in the embodiment of the present disclosure, the processing unit can determine whether the images to be displayed are special images by other similar manners, to which no limitation is given herein.

It should be noted that the display apparatus provided in the embodiments of the present disclosure may be any product or means having the display function such as a mobile phone, a tablet computer, a television set, a display, a notebook computer, a digital photo frame, and a navigator and so on. The implementation of the display apparatus can refer to the embodiments of the above display method, and thus no further description is given herein.

There are provided in the embodiments of the present disclosure a display method and a display apparatus. The display method comprises: determining whether the images to be displayed are special images; transmitting instructions corresponding to the images to be displayed when it is determined that the images to be displayed are special images; receiving instructions, generating image data of the images to be displayed according to the instructions, and transmitting the image data; receiving the image data, and displaying the images to be displayed according to the image data; by classifying the images to be displayed, for a special image, a mode of firstly transmitting the instructions corresponding to the images to be displayed and then generating the image data of the images to be displayed according to the instructions is adopted. Compared with the existing mode of transmitting the image data of the images to be displayed, this mode would reduce volume of data transmitted. In this way, it can not only reduce power consumption of the display apparatus, but also increase transmission efficiency, so that the frame frequency of displaying images by a display apparatus can be ensured without increasing the transmission rate of the signal line, so as to avoid the problem of producing electromagnetic interference.

Obviously, those skilled in the art could make various variations and modifications to the present disclosure without departing from the spirit and scope of the present disclosure. As such, if these amendments and modifications of the present disclosure belong to the scope of the claims of the present disclosure as well as their equivalents, then the present disclosure also intends to comprise these amendments and modifications.

The present application claims the priority of a Chinese patent application No. 201510427672.5 filed on Jul. 20, 2015. Herein, the content disclosed by the Chinese patent application is incorporated in full by reference as a part of the present disclosure.

1. A display method, comprising:
determining whether images to be displayed are special images;
transmitting instructions corresponding to the images to be displayed when it is determined that the images to be displayed are special images;
receiving the instructions, generating image data of the images to be displayed according to the instructions, and transmitting the image data; and
receiving the image data, and displaying the images to be displayed according to the image data.

2. The method according to claim 1, further comprising:
transmitting image data of the images to be displayed when it is determined that the images to be displayed is not a special image; and
receiving the image data, and displaying the images to be displayed according to the image data.

3. The method according to claim 1, wherein the determining whether the images to be displayed are special images comprises:
determining whether the images to be displayed are special images according to gray scale values of all sub-pixels in the images to be displayed.

4. The method according to claim 3, wherein the determining whether the images to be displayed are special images according to gray scale values of all sub-pixels in the images to be displayed comprises:
determining whether gray scale values of sub-pixels with a same chromatic resistance color in the images to be displayed are the same; if yes, determining that the images to be displayed are special images.

5. The method according to claim 3, wherein the determining whether the images to be displayed are special images according to the gray scale values of all sub-pixels in the images to be displayed comprises:
determining whether the gray scale values of all sub-pixels in the images to be displayed change gradually in a horizontal direction or in a vertical direction and change values are determined; if yes, determining that the images to be displayed are special images.

6. The method according to claim 1, further comprising: classifying the images to be displayed, so as to determine which images to be displayed are special images.

7. A display apparatus, comprising:
a processing unit, configured to determine whether images to be displayed are special images, and transmit instructions corresponding to the images to be displayed when it is determined that the images to be displayed are special images;
a driving unit, configured to receive the instructions, generate image data of the images to be displayed according to the instructions, and transmit the image data; and
a display unit, configured to receive the image data, and display the images to be displayed according to the image data.

8. The apparatus according to claim 7, wherein the processing unit is further configured to transmit the image data of the images to be displayed when it is determined that the images to be displayed is not a special image; and
the driving unit is further configured to receive and transmit the image data.

9. The apparatus according to claim 7, wherein the processing unit is configured to determine whether the images to be displayed are special images according to the gray scale values of all sub-pixels in the images to be displayed.

10. The apparatus according to claim 9, wherein the processing unit is configured to determine whether gray scale values of sub-pixels with a same chromatic resistance color in the images to be displayed are the same, and determine that the images to be displayed are special images when it is determined that the gray scale values of the sub-pixels with a same chromatic resistance color in the images to be displayed are the same.

11. The apparatus according to claim 9, wherein the processing unit is configured to determine whether the gray scale values of all sub-pixels in the images to be displayed change gradually in a horizontal direction or in a vertical direction and change values are determined, and determine that the images to be displayed are special images when it is determined that the gray scale values of all sub-pixels in the images to be displayed change gradually in a horizontal direction or in a vertical direction and change values are determined.

12. The apparatus according to claim 7, further comprising: a classifying unit configured to classify the images to be displayed, so as to determine which images to be displayed are special images.

13. The method according to claim 2, wherein the determining whether the images to be displayed are special images comprises:
determining whether the images to be displayed are special images according to gray scale values of all sub-pixels in the images to be displayed.

14. The method according to claim 13, wherein the determining whether the images to be displayed are special images according to gray scale values of all sub-pixels in the images to be displayed comprises:
determining whether gray scale values of sub-pixels with a same chromatic resistance color in the images to be displayed are the same; if yes, determining that the images to be displayed are special images.

15. The method according to claim 13, wherein the determining whether the images to be displayed are special images according to the gray scale values of all sub-pixels in the images to be displayed comprises:
determining whether the gray scale values of all sub-pixels in the images to be displayed change gradually in a horizontal direction or in a vertical direction and change values are determined; if yes, determining that the images to be displayed are special images.

16. The method according to claim 2, further comprising: classifying the images to be displayed, so as to determine which images to be displayed are special images.

17. The apparatus according to claim 8, wherein the processing unit is configured to determine whether the images to be displayed are special images according to the gray scale values of all sub-pixels in the images to be displayed.

18. The apparatus according to claim 17, wherein the processing unit is configured to determine whether gray scale values of sub-pixels with a same chromatic resistance color in the images to be displayed are the same, and determine that the images to be displayed are special images when it is determined that the gray scale values of the sub-pixels with a same chromatic resistance color in the images to be displayed are the same.

19. The apparatus according to claim 17, wherein the processing unit is configured to determine whether the gray scale values of all sub-pixels in the images to be displayed change gradually in a horizontal direction or in a vertical direction and change values are determined, and determine that the images to be displayed are special images when it is determined that the gray scale values of all sub-pixels in the images to be displayed change gradually in a horizontal direction or in a vertical direction and change values are determined.

20. The apparatus according to claim 8, further comprising: a classifying unit configured to classify the images to be displayed, so as to determine which images to be displayed are special images.
